(19) United States
(12) Patent Application Publication
(10) Pub. No.: US 2005/0058042 A1
(43) Pub. Date: Mar. 17, 2005

(54) Sensing media speed

(76) Inventors: Darwin Mitchel Hanks, Fort Collins, CO (US); Andrew L. Van Brocklin, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/661,189

(22) Filed: Sep. 12, 2003

(51) Int. Cl. G11B 7/00

(52) U.S. Cl. 369/53.22; 369/53.3

(57) ABSTRACT

A method of using electromagnetic radiation to control exposure of media to electromagnetic radiation is presented. The method includes rotating the media and sensing a frequency of electromagnetic radiation radiating from a rim of the media with a stationary detector. Exposure of the media to electromagnetic radiation with a movable source is controlled with the sensed frequency to provide increased accuracy.

### RELATED APPLICATIONS

This patent application is related to commonly assigned U.S. patent application Ser. No. ______, titled “Optical Disk Drive Modified for Speed Orientation Tracking,” attorney docket no. 200315232, filed concurrently herewith and hereby incorporated by reference.

### FIELD OF THE INVENTION

This invention relates in general to sensing media speed and accurately controlling media speed and accuracy and, more particularly, to using electromagnetic radiation sensed from the media to control accurate placement of exposure of the media to electromagnetic radiation.

### BACKGROUND OF THE INVENTION

It is often desirable to accurately know the speed at which media is rotating. In addition, operating a motor at low speeds allows friction forces to vary the speed (thus creating wobble) within a single rotation. Further, slippage of media on a spindle at high or low speeds causes errors in writing to media. Accurately knowing the actual speed and position of the media would allow more precise reading from and writing to the media.

For some media (such as CDs, DVDs, and their variants), timing information is encoded into the data tracks of the media or encoded within a wobbled groove. A laser accessing conventional data media can accurately determine the media's rotational speed using the encoded timing information within the data tracks.

For other media, timing information is not encoded into the tracks. The laser accessing the media cannot be used to determine the media's rotational speed from the media tracks. Therefore, if the speed is not accurately known, errors may occur in writing to or reading from the media.

### SUMMARY OF THE INVENTION

A method of using electromagnetic radiation to control exposure of media to electromagnetic radiation is presented. The method includes rotating the media and sensing a frequency of electromagnetic radiation radiating from a rim of the media with a stationary detector. Exposure of the media to electromagnetic radiation with a movable source is controlled with the sensed frequency to provide increased accuracy.

### DESCRIPTION OF THE DRAWINGS

FIG. 1 is a depiction of one embodiment of the present invention mass storage device using electromagnetic radiation to control exposure of media to electromagnetic radiation.

FIG. 2 represents a cross-sectional illustration of the mass storage device of FIG. 1.

FIG. 3 is a depiction of an alternate embodiment of the present invention mass storage device using electromagnetic radiation to control exposure of media to electromagnetic radiation.

FIG. 4 represents a cross-sectional illustration of the mass storage device of FIG. 3.

FIG. 5 is a flow chart illustrating one embodiment of the present invention method for method for using electromagnetic radiation to control exposure of media to electromagnetic radiation.

### DETAILED DESCRIPTION OF THE INVENTION

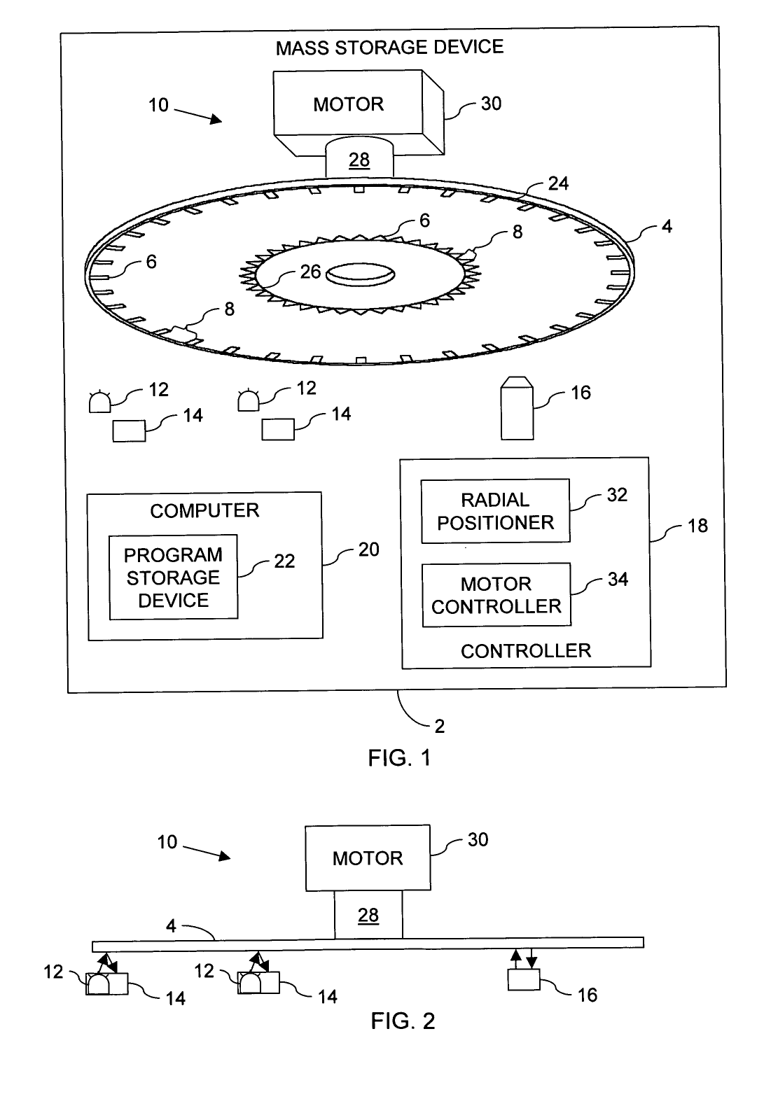

Illustrated in FIGS. 1 and 2 is one embodiment of a mass storage device 2 of the present invention. In one embodiment, mass storage device 2 includes mass storage media 4, rotation device 10, electromagnetic radiation sensor 14, electromagnetic radiation emitter 16, controller 18, and optionally, reflective regions 6, non-reflective regions 8, electromagnetic radiation source 12, computer 20 and program storage system 22. Mass storage device 2 is preferably and optical disc drive although it could be another form of mass storage such as a magnetic, electronic, physical, or atomic resolution device.

Mass storage media 4 is any media upon which information may be stored and is preferably removable and replaceable. Mass storage media has at least an inner rim 26 and, optionally an outer rim 24. In one embodiment, mass storage media 4 is an optical disc such as a CD, CD-R, CD-RW, CD+RW, DVD, DVD-R, DVD-R/W, or DVD+RW drive just to name a few. While the media is preferably circular, the media may be one of many shapes, such as a credit card format, or CD mini disc, to name a couple of conventional choices. The inner rim 26 and outer rim 24 may be on one or both sides of the media.

In one embodiment, at least one reflective region 6 and one non-reflective region 8 are aligned circularly on media 4 about the outer rim 24. In an alternate embodiment, the reflective and non-reflective regions are aligned about inner rim 26. As an example, FIG. 1 illustrates both embodiments. In practice, the reflective 6 and non-reflective 8 regions may be aligned about either or both rims 24, 26 on one or both sides of the media 4.

The reflective 6 and non-reflective 8 regions are any suitable shape. In one embodiment, reflective 6 and non-reflective 8 regions are arranged in a spoke pattern on media 4, as shown in FIG. 1 at the outer rim 24. In an alternate embodiment, reflective 6 and non-reflective 8 regions are arranged in a gear-tooth pattern on media 4, as shown in FIG. 1 at the inner rim 26. In practice, either or both patterns may be used at either rim 24, 26 alone or in combination with each other. That is, both spokes and gears may be present on one pattern. One advantage of the gear tooth pattern is that it can be used to determine accurate radial positioning. This locating of radial positioning is done by using the electromagnetic source 16 to scan the width of the gear tooth pattern such as described in commonly assigned U.S. patent application Ser. No. 10/347,074 entitled “Radial Position Registration For A Trackless Optical Disc Surface”, and filed on Jan. 17, 2003 and is incorporated herein by reference.

In an alternate embodiment, reflective regions 6 are instead magnetic regions 6 and non-reflective regions 8 are instead non-magnetic regions 8. In this embodiment, no electromagnetic radiation source 12 is necessary aside from magnetic regions 6, as magnetic regions 6 are themselves sources of electromagnetic radiation.

In either embodiment, the pattern of reflective 6 and non-reflective 8 regions or magnetic 6 and nonmagnetic 8 regions may be describe and used as an encoder ring for media 4 in conjunction with electromagnetic radiation source 12 and electromagnetic radiation sensor 16.

Rotation device 10 is any combination of hardware and executable code configured to rotate media 4. In one embodiment, rotation device 10 for rotating media 4 includes spindle 28 and motor 30. Spindle 28 is coupled to media 4 and motor 30 is coupled to spindle 28. Motor 30 operates on spindle 28, rotating and positioning media 4. Examples of motor 30 include a stepper motor and a voice coil motor. Operation of the motor is controlled by motor controller 34 which controls the amount of power by varying voltage and/or current to the motor to maintain speed.

Electromagnetic radiation source 12 is any source of electromagnetic radiation. Examples of electromagnetic radiation include visible light, infrared radiation, ultraviolet light, heat, magnetic fields, and electron beams. Alternatively, electromagnetic radiation can be expressed as being photons or electrons of energy emitted from electromagnetic radiation source 12. In one embodiment, electromagnetic radiation source 12 is fixed (stationary) in position and directed towards either outer rim 24 or inner rim 26. In another embodiment, electromagnetic radiation source 12 may be movable to be directed at one or more patterns on media 4.

In one embodiment, electromagnetic radiation source 12 is a non-coherent electromagnetic radiation source, such as a light (including infrared an ultraviolet) emitting diode. In an alternative embodiment, electromagnetic radiation source 12 is a coherent electromagnetic radiation source, such as a laser. Electromagnetic radiation source 12 is directed at either one or both rims 24, 26 upon which reflective 6 and non-reflective 8 regions are arranged.

Electromagnetic radiation sensor 14 is any combination of hardware and executable code device configured to sense electromagnetic radiation radiated from reflective or magnetic regions 6. In one embodiment, the electromagnetic radiation radiated from reflective or magnetic regions 6 originates from electromagnetic radiation source 12. Electromagnetic radiation sensor 14 is positioned to sense electromagnetic radiation radiated from each reflective or magnetic region 6 as media 4 rotates. Optionally, there is more than one electromagnetic radiation sensor 14.

As media 4 rotates, electromagnetic radiation sensor 14 senses electromagnetic radiation radiated from each reflective or magnetic region 6 to sense the frequency (or waveform) of electromagnetic radiation radiated from reflective or magnetic regions 6 due to the pattern sensed from the rim. Electromagnetic radiation sensor 14 produces an output signal indicative of the frequency of electromagnetic radiation radiated from reflective or magnetic regions 6.

Electromagnetic radiation emitter 16 is any device configured to produce electromagnetic radiation directed at media 4. Examples of electromagnetic radiation include visible light, infrared radiation, ultraviolet light, heat, magnetic fields, and electron beams. Alternatively, the electromagnetic radiation form emitter 16 can be expressed as photons or electrons.

In one embodiment, electromagnetic radiation emitter 16 is a laser emitter that emits a coherent beam of electromagnetic radiation. In an alternate embodiment, electromagnetic radiation emitter 16 emits a non-coherent beam of electromagnetic radiation, such as an LED or thermal printhead.

Controller 18 is coupled to electromagnetic radiation sensor 14 to received input from electromagnetic radiation sensor 14. Controller 18 is any combination of hardware and executable code configured to use a sensed frequency of radiated electromagnetic radiation to control exposure of media 4 to electromagnetic radiation from emitter 16 to create pixels or alternatively solid marks. Pixels are discrete markings (dots) typically formed in an array. The array may be formed in a series of concentric circles or arranged along a spiral path. Alternatively, the array of pixels may be formed in an (X,Y) array. Although pictured and discussed as separate from computer 20, controller 18 is alternatively integral with computer 20. Controller 18 may be formed of integrated circuits, programmable arrays, discrete electrical components, physical components, executable code (such as firmware or software) or combination thereof. The pixels may be formed in an array of typically 75, 100, 300, 600, 1200, or 2400 dpi (dots per inch) as examples. The pixels may be separated by a short unmarked portion or alternatively the pixels may have no unmarked portions when adjacent. In some embodiments, the pixels may be allowed to overlap one another.

In one embodiment, controller 18 includes radial positioner 32 configured to control the placement of a beam of electromagnetic radiation on media 4 based on the controlled motor speed and radial positioner 32. Radial positioner 32 is any combination of hardware and executable code configured to control the placement of a beam of electromagnetic radiation on media 4.

In another embodiment, controller 18 includes motor controller 34. Motor controller is any combination of hardware and executable code configured to control motor 30. Controlling motor 30 controls the rotation of media 4.

Computer 20 is any combination of hardware and executable code configured to execute executable code stored in program storage system 22. Program storage system 22 is any device or system configured to store data or executable code. Program storage system 22 may also be a program storage system tangibly embodying a program, applet, or instructions executable by computer 20 for performing the method steps of the present invention executable by computer 20. Program storage system 22 may be any type of storage media such as magnetic, optical, or electronic storage media.

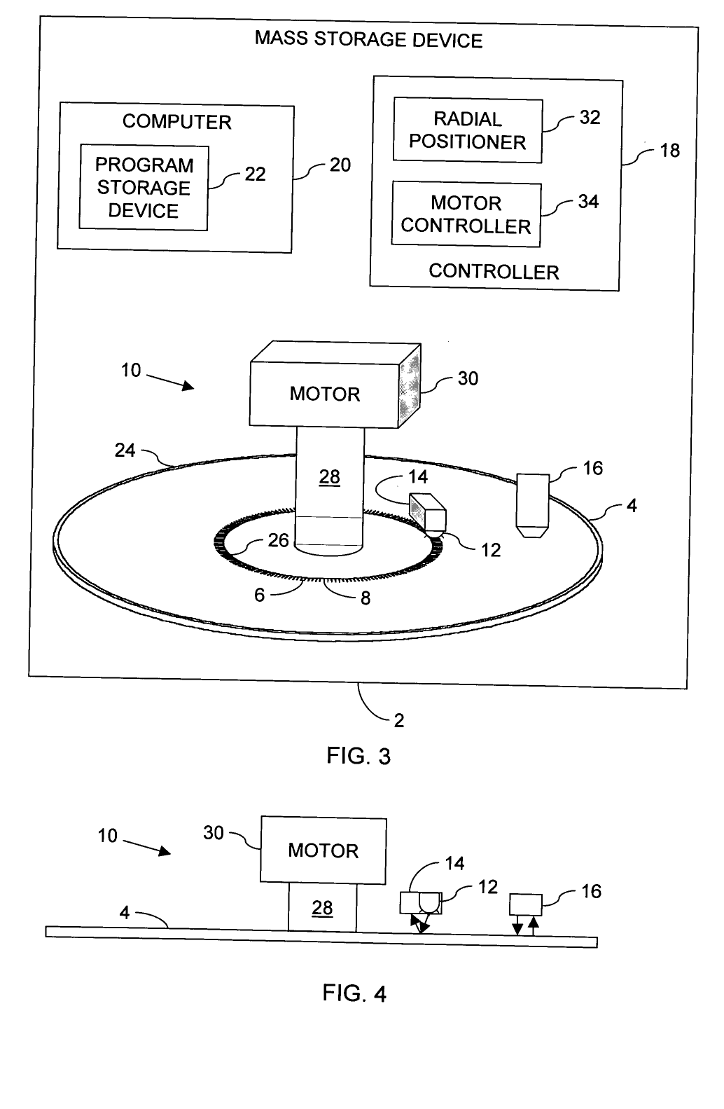

Illustrated in FIGS. 3 and 4 is an alternate embodiment of mass storage device 2. FIG. 3 shows another embodiment of reflective 6 and non-reflective 8 regions arranged in a spoke pattern on media 4 about inner rim 26. Additionally, reflective 6 and non-reflective 8 regions, electromagnetic radiation source 12, electromagnetic radiation sensor 14, electromagnetic radiation emitter 16 are positioned on the same side of media 4 as rotation device 10.

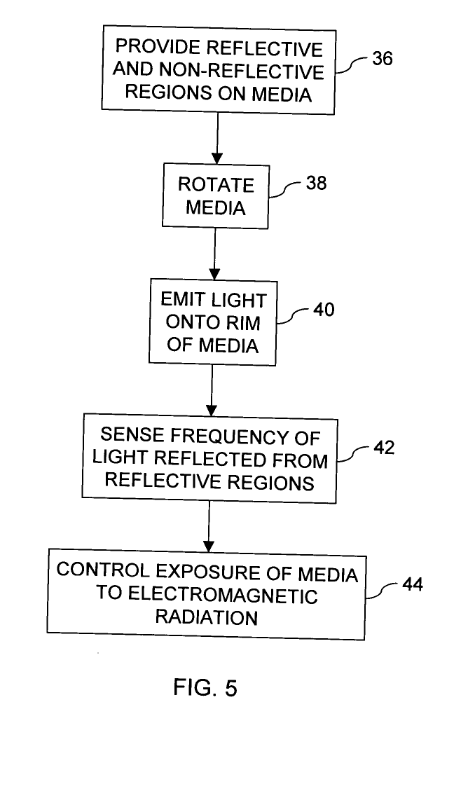

FIG. 5 is a flow chart representing steps of one embodiment of the present invention. Although the steps represented in FIG. 5 are presented in a specific order, the present invention encompasses variations in the order of steps. Furthermore, additional steps may be executed between the steps illustrated in FIG. 5 without departing from the scope of the present invention.

In one embodiment, at least one reflective 6 and one non-reflective 8 region are provided 36 on media 4. The reflective 6 and non-reflective 8 regions are aligned circularly about either or both rims 24, 26 of media 4. In one embodiment, providing 36 reflective 6 and non-reflective 8 regions includes providing 36 the reflective 6 and non-reflective 8 regions in a spoke pattern on media 4. In an alternate embodiment, providing 36 reflective 6 and non-reflective 8 regions includes providing 36 reflective 6 and non-reflective 8 regions in a gear-tooth pattern on media 4.

In an alternate embodiment, reflective regions 6 are instead magnetic regions 6 and non-reflective regions 8 are instead non-magnetic regions 8.

In one embodiment, providing 36 reflective 6 and non-reflective 8 regions includes providing 36 reflective 6 and non-reflective 8 regions about outer rim 24 of media 4. In one embodiment, providing 36 reflective 6 and non-reflective 8 regions includes providing 36 reflective 6 and non-reflective 8 regions about inner rim 26 of media 4.

Media 4 is rotated 38. In one embodiment, electromagnetic radiation is emitted 40 onto either or both rims 24, 26 of media 4 as media 4 rotates 38. In one embodiment, the electromagnetic radiation emitted 40 is non-coherent electromagnetic radiation. In one embodiment, the electromagnetic radiation emitted 40 is coherent electromagnetic radiation.

In an alternate embodiment, no electromagnetic radiation is emitted onto either rim 24, 26. Instead, electromagnetic radiation is radiated from magnetic regions 6.

A frequency of electromagnetic radiation radiated from reflective or magnetic regions 6 is sensed 42. The frequency of electromagnetic radiation radiated from reflective or magnetic regions 6 is indicative of the rotational speed of media 4 and hence it accuracy as it rotates through one cycle.

Exposure of media 4 to electromagnetic radiation is controlled 44 with the sensed frequency such as to form pixels. In one embodiment, controlling 44 exposure of media 4 to electromagnetic radiation includes controlling 44 a placement of a beam of the electromagnetic radiation on media 4.

In another embodiment, controlling 44 exposure of media 4 to electromagnetic radiation includes controlling the rotation of media 4 by use of power control based on the electromagnetic radiation sensed from the pattern on the rim. Examples of controlling the rotation of media 4 include regulating motor 30 to control the rotational speed of spindle 28 and regulating motor 30 to control the rotational accuracy of spindle 28. The rotation of spindle 28 determines the rotation of media 4. By monitoring the pattern of the encoder on the media in a rim area, if the media slips on the spindle, the motor speed can be adjusted to compensate and still allow for accurate placement of a pixel by the controlled exposure of electromagnetic source 16 to the media 4.

In one embodiment, the controlled exposure to electromagnetic radiation is controlled exposure to coherent electromagnetic radiation. In an alternative embodiment, the controlled exposure to electromagnetic radiation is controlled exposure to non-coherent electromagnetic radiation.

One advantage of the present invention system and method is that the rotational speed of media 4 is determined from sensing electromagnetic radiation radiated from media 4, and not from rotation device 10. This is advantageous in many ways. For example, should media 4 slip on spindle 28, the rotational speed of media 4 is still measured accurately. Additionally, a motor 30 without a complex speed control system or with a reduced number of Hall sensors may be used, since changes in speed may be either compensated for or corrected by the present invention as the pattern formed on the rim may contain multiple segments, such as for example 300 or more. For example, if 360 segments are formed in a spoke or gear tooth pattern, the rotational speed can be updated at least each degree of revolution and possibly more such as using both edges of the pattern. Since the pattern on the media may be formed by silkscreen, stamped, or molded the cost of adding more segments is less costly and more adaptable than adding additional Hall sensors to the motor. These types of motors 30 (typically found on conventional drives) are less expensive than motors 30 with more complex speed control systems or more Hall sensors.

Furthermore, typical motor control systems for optical media are not accurate at rotational speeds of 0.25 meters per second since speeds that low are not normally used in optical media systems. However, since, in the present invention, the exposure of media 4 to electromagnetic radiation is controlled by the sensed frequency of electromagnetic radiation radiated from media 4, the speed of spindle 28 may be controlled even at slow speeds such as at 0.25 meters per second and at an accuracy of ±0.02%. Accuracy in this context is defined as the percent change in motor speed within one rotation of the media. Any changes in motor speed during one rotation that is due to striction, disk or spindle slippage, motor aberrations, changes in power levels, or other factors can be compensated for by feeding the sensed frequency of electromagnetic radiation from the media to the motor controller circuit. This sensed media feedback motor control scheme provides an accuracy of placement that allows for the placement of a pixel to within a quarter of a pixel at 600 dots per inch or better.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

1. A method of using electromagnetic radiation to control exposure of media to electromagnetic radiation, the method comprising:
rotating the media;
sensing a frequency of electromagnetic radiation radiating from a rim of the media with a stationary detector; and
controlling, with the sensed frequency, exposure of the media to electromagnetic radiation with a movable source.

2. The method of claim 1 further including:
providing at least one reflective and one non-reflective region on the media, aligned circularly about the rim of the media,
emitting electromagnetic radiation onto the rim of the media as the media rotates, and
wherein the electromagnetic radiation radiated from the rim originated from the electromagnetic radiation source directed at the rim.

3. The method of claim 2 wherein providing the reflective and non-reflective regions includes providing the reflective and non-reflective regions in a spoke pattern on the media.

4. The method of claim 2 wherein providing the reflective and non-reflective regions includes providing the reflective and non-reflective regions in a gear-tooth pattern on the media.

5. The method of claim 2 wherein emitting the electromagnetic radiation onto the rim of the media includes emitting coherent electromagnetic radiation.

6. The method of claim 2 wherein emitting the electromagnetic radiation onto the rim of the media includes emitting non-coherent electromagnetic radiation.

7. The method of claim 1 wherein sensing the frequency of electromagnetic radiation radiating from the rim of the media includes sensing the frequency of electromagnetic radiation radiating from an inner rim of the media.

8. The method of claim 1 wherein sensing the frequency of electromagnetic radiation radiating from the rim of the media includes sensing the frequency of electromagnetic radiation radiating from an outer rim of the media.

9. The method of claim 1 wherein controlling the exposure of the media to electromagnetic radiation includes controlling the exposure of the media to coherent electromagnetic radiation.

10. The method of claim 1 wherein controlling the exposure of the media to electromagnetic radiation includes controlling the exposure of the media to non-coherent electromagnetic radiation.

11. The method of claim 1 wherein controlling exposure of the media to electromagnetic radiation includes controlling a placement of a beam of the electromagnetic radiation on the media.

12. The method of claim 1 wherein controlling exposure of the media to electromagnetic radiation includes controlling the rotation of the media.

13. A mass storage device comprising;
a rotation device configured to rotate mass storage media having a rim;
an electromagnetic radiation sensor configure to sense a frequency of electromagnetic radiation radiated from the rim of the media as the media rotates;
an electromagnetic radiation emitter; and
a controller, coupled to the electromagnetic radiation sensor, the controller configured to control, with a sensed frequency of electromagnetic radiation radiated from the rim, exposure of the media to electromagnetic radiation from the electromagnetic radiation emitter.

14. The mass storage device of claim 13 further including an electromagnetic radiation source directed at the rim, wherein at least one reflective and one non-reflective region are aligned circularly on the media about the rim, and wherein the electromagnetic radiation radiated from the rim originated from the electromagnetic radiation source directed at the rim.

15. The mass storage device of claim 14 wherein the sensor is disposed to sense electromagnetic radiation reflected from a spoke pattern on the media.

16. The mass storage device of claim .14 wherein the sensor is disposed to sense electromagnetic radiation reflected from a gear-tooth pattern on the media.

17. The mass storage device of claim 14 the electromagnetic radiation source includes a coherent electromagnetic radiation source.

18. The mass storage device of claim 14 the electromagnetic radiation source includes a non-coherent electromagnetic radiation source.

19. The mass storage device of claim 13 wherein the rotation device includes:
a spindle coupled to the media and
a motor coupled to the spindle.

20. The mass storage device of claim 13 wherein the controller includes a motor controller configured to control the motor.

21. The mass storage device of claim 13 wherein the sensor is disposed to sense electromagnetic radiation radiated from an inner rim of the media.

22. The mass storage device of claim 13 wherein the sensor is disposed to sense electromagnetic radiation radiated from an outer rim of the media.

23. The mass storage device of claim 13 the electromagnetic radiation emitter includes a coherent electromagnetic radiation emitter.

24. The mass storage device of claim 13 the electromagnetic radiation emitter includes a non-coherent electromagnetic radiation emitter.

25. The mass storage device of claim 13 wherein the controller includes radial positioner for controlling a placement of a beam of the electromagnetic radiation on the media.

26. A mass storage device having media that is rotateable, comprising;
means for sensing electromagnetic radiation with a stationary sensor from a rim of the media;
means for controlling the rotational speed of the media based on the sensed electromagnetic radiation;
means for positioning radially an electromagnetic source with respect to a surface of the media; and
means for controlling exposure of the media by the electromagnetic source in conjunction with the means for controlling and the means for positioning.

27. The mass storage device of claim 26 further including means for sourcing electromagnetic radiation directed at the rim, wherein at least one reflective and one non-reflective region are aligned circularly on the media about the rim, and wherein the electromagnetic radiation radiated from the rim originated from the electromagnetic radiation source directed at the rim.

28. The mass storage device of claim 27 wherein the means for sensing is disposed to sense electromagnetic radiation from a spoke pattern on the media.

29. The mass storage device of claim 27 wherein the means for sensing is disposed to sense electromagnetic radiation from a gear-tooth pattern on the media.

30. The mass storage device of claim 27 the means for sourcing electromagnetic radiation includes a coherent electromagnetic radiation source.

31. The mass storage device of claim 27 the means for sourcing electromagnetic radiation includes a non-coherent electromagnetic radiation source.

32. The mass storage device of claim 27 the means for sourcing electromagnetic radiation includes a coherent electromagnetic radiation emitter.

33. The mass storage device of claim 27 the means for sourcing electromagnetic radiation includes a non-coherent electromagnetic radiation emitter.

34. The mass storage device of claim 26 wherein the means for controlling the rotational speed includes:
a spindle coupled to the media and
a motor coupled to the spindle.

35. The mass storage device of claim 26 wherein the means for controlling rotational speed includes a motor controller configured to control the rotational speed of the media to 0.25 meters/second at an accuracy of 0.02 percent.

36. The mass storage device of claim 26 wherein the means for sensing is disposed to sense electromagnetic radiation radiated from an inner rim of the media.

37. The mass storage device of claim 26 wherein the means for sensing is disposed to sense electromagnetic radiation radiated from an outer rim of the media.

38. The mass storage device of claim 26 wherein the means for controlling includes placement means for controlling a placement of a beam of the electromagnetic radiation on the media.

39. A program storage system readable by a computer, tangibly embodying a program, applet, or instructions executable by the computer to perform method steps for using sensed electromagnetic radiation to control exposure of media to a first source of electromagnetic radiation, the media having at least one patterned region aligned circularly about a rim of the media, the method comprising:
rotating the media;
sensing a frequency of electromagnetic radiation from the at least one patterned region; and
controlling, with the sensed frequency, exposure of the media with the first source of electromagnetic radiation.

40. The program storage system of claim 39, further comprising emitting electromagnetic radiation to the patterned region using a second source of electromagnetic radiation.

41. The program storage system of claim 40 wherein emitting electromagnetic radiation using a second source includes emitting non-coherent electromagnetic radiation.

42. The program storage system of claim 39 wherein controlling the exposure of the media with the first source of electromagnetic radiation includes controlling the exposure of the media to coherent electromagnetic radiation.

43. The program storage system of claim 39 wherein controlling exposure of the media with the first source of electromagnetic radiation includes controlling a placement of a beam of the electromagnetic radiation on the media.

44. The program storage system of claim 39 wherein controlling exposure of the media with the first source of electromagnetic radiation includes controlling the rotation of the media based on the sensed electromagnetic radiation form the rim.

45. The program storage system of claim 39 wherein controlling exposure of the media with the first source of electromagnetic radiation includes controlling the rotational speed of a spindle onto which the media is fixed based on the sensed frequency of electromagnetic radiation from the at least one patterned region.

46. The program storage system of claim 39 wherein controlling exposure of the media with the first source of electromagnetic radiation includes controlling the rotational accuracy of a spindle onto which the media is fixed to allow placement to within a quarter of a pixel at 600 dpi on the media.

47. An optical disc drive for replaceable media, comprising:
an optical encoder having a first photon source and a first photon sensor disposed at a stationary location within a rim area of the optical disc drive wherein the first photon source is configured to reflect photons from a pattern located in the rim area on a media disposed in the optical disc drive;
an optical pickup unit having a second photon source and a second photon sensor disposed on a movable positioning unit;
a motor unit having a spindle for placement of the media while in the optical disc drive to allow for rotation of the media;
a control circuit that uses the first photon sensor to detect the rotational speed of the media from the pattern and that adjusts power to the motor unit to maintain precise rotational speed and accuracy while controlling the exposure to the media with the second photon source.

48. The optical disc drive of claim 47 wherein the first photon source is a non-coherent source.

49. The optical disc drive of claim 47 wherein the rim area is located in the inner hub of the media near the spindle.

50. The optical disc drive of claim 47 wherein the accuracy is maintained by the control circuit to allow for placement of a pixel on the media to within ¼ of a pixel location at 600 dpi.
